(19) United States
(12) Patent Application Publication
(10) Pub. No.: US 2021/0224707 A1
(43) Pub. Date: Jul. 22, 2021

(54) IDENTIFYING BOTTLENECKS IN SCHEDULES

(71) Applicant: Bayer Aktiengesellschaft, Leverkusen (DE)

(72) Inventors: Andreas BLANK, Berlin (DE); Hendrik ESCH, Leverkusen (DE); Tobias SCHUON, Leverkusen (DE); Lars ROTHE, Köln (DE)

(73) Assignee: Bayer Aktiengesellschaft, Leverkusen (DE)

(21) Appl. No.: 17/154,900

(22) Filed: Jan. 21, 2021

(30) Foreign Application Priority Data
Jan. 22, 2020 (EP) 20153089.6

(51) Int. Cl. G06Q 10/06; G06Q 10/04; G06Q 50/28; G06F 17/12

(52) U.S. Cl. CPC G06Q 10/06311; G06Q 10/04; G06F 17/12; G06Q 50/28; G06Q 10/06313

(57) ABSTRACT

The present disclosure pertains to the identification of bottlenecks in schedules for carrying out a plurality of tasks using limited resources. Provided herein are a computer system, a computer program product and a method for identifying bottlenecks in schedules.

### CROSS REFERENCE TO RELATED APPLICATIONS

This application claims priority benefit to European Application No. 20153089.6, filed Jan. 22, 2020, the disclosure of which is herein incorporated by reference in its entirety.

### FIELD OF THE DISCLOSURE

The present disclosure is concerned with the identification of bottlenecks in schedules for carrying out a plurality of tasks using limited resources. Subjects of the present disclosure are a computer system, a computer program product and a method for identifying bottlenecks in schedules.

### BACKGROUND OF THE DISCLOSURE

There are a multiplicity of areas and conditions in which schedules have to be created. The packaging of medicaments shall be mentioned as one example. En route from the manufacturer to the user, medicaments are protected by packaging. The packaging ensures the intactness, shelf life and also the suitable and user-friendly removal of the product. However, further requirements are made of medicament packagings since the packaging together with its labelling is a fixed part of a finished medicament; it must be approved in the context of approval. Besides product protection, care must be taken primarily to ensure that during production mistakes and contamination are precluded, the packaging is labelled correctly and it contains all necessary information for safe and proper use. In Germany the law regarding trade with medicaments also regulates, inter alia, the labelling of the packaging of medicaments (see, in particular, § 10 AMG). The requirements made of a packaging are usually country-specific; different packagings are usually used for each country.

The slogan “Good Manufacturing Practice” (abbreviated to GMP) summarizes guidelines for quality assurance for the production sequences and production environment in the production of medicaments and active ingredients, but also in the case of cosmetics, foodstuffs and animal feeds. The EU GMP guide for human and animal medicaments concretizes the directive 2003/94/EC for defining the principles and guidelines of Good Manufacturing Practice for human medicaments and for investigational medicinal products intended for use by human beings, and the directive 1991/412/EEC for defining the principles and guidelines of Good Manufacturing Practice for animal medicaments. Part II Section 9 includes guidelines for packaging and labelling. In the USA, the guidelines of Current Good Manufacturing Practice (cGMP) are set out in the Code of Federal Regulations (CFR), the collection of legal texts of the United States of America, under 21 CFR 210 and 21 CFR 211.

The packaging of medicaments is thus subject to strict guidelines.

Medicaments are often packaged by means of a plurality of packaging lines. A packaging line usually comprises a plurality of units (modules) that perform different functions: filling, guiding, folding, enclosing, cutting, perforating, laminating, printing, moving, stacking, adhesive bonding and many more. The lines and units here are usually usable modularly and flexibly, such that different medicaments can be packaged on one packaging line, if appropriate after retooling. However, since there are various administration forms of medicaments (inter alia tablets, capsules, tinctures, ointments) and/or the packaging units vary in their size and shape, a packaging plant usually has a plurality of variously usable packaging lines and units.

In the period in which a packaging line is used for packaging one specific medicament, it cannot simultaneously be used for packaging another specific medicament. The resources are thus usually limited, and so a decision has to be taken regarding which medicament is intended to be packaged in which period.

It is also customary for differently qualified employees to be needed for operating/supervising different packaging lines and apparatuses. That means that an availability of a packaging line does not necessarily mean that it can actually be used for packaging (for example not if there are no qualified personnel to operate the packaging line).

Further limitations can result from the fact that packaging lines and/or modules have to be retooled and/or maintained, and/or GMP updates (GMP upgrade) are required. Stoppages can also result from the need for serialization and/or tracking (Track&Trace) of products and/or other requirements for satisfying official stipulations.

### SUMMARY OF THE DISCLOSURE

For packaging a plurality of different medicaments in a packaging plant, it is therefore expedient to create a schedule which is optimized with respect to an optimization aim.

A schedule which is optimized with respect to an optimization aim usually represents the best solution for fulfilling a task under the given boundary conditions. However, it is not immediately evident from the schedule what bottlenecks are present and how the existing resources should be adapted in order to make it possible to achieve a higher performance in the future.

The present disclosure describes systems and methods configured to identify bottlenecks in schedules and thus to optimize resources in a targeted manner.

According to some embodiments, a computer system comprises:
a database or a plurality of databases in which resource information about resources is stored,
a receiving unit,
a control and computing unit, and
an output unit,

wherein the control and computing unit is configured to cause the receiving unit to receive task information, wherein the task information specifies at least a plurality of process objects which are each intended to be supplied to one or more processes,

wherein the control and computing unit is configured to specify, on the basis of the task information, processes to which the process objects are intended to be supplied,

wherein the control and computing unit is configured to specify, on the basis of the specified processes, resources which are intended to be used for carrying out the processes,

wherein the control and computing unit is configured to create a schedule, wherein the schedule comprises details relating to

the periods in which the processes are intended to be carried out,

the resources which are intended to be used for carrying out the processes, wherein the schedule is optimized with respect to an optimization aim,

wherein the control and computing unit is configured to determine a capacity utilization value for at least one resource, to compare the capacity utilization value with a reference value and, in the case of a defined deviation of the capacity utilization value from the reference value, to cause the output unit to output a notification regarding the deviation.

In some embodiments, a computer program product comprises a data storage medium which stores a computer program which can be loaded into the main memory of a computer system and there causes the computer system to:
receiving task information, wherein the task information specifies at least a plurality of process objects which are each intended to be supplied to one or more processes,
receiving or determining process information, wherein the process information specifies the processes to which the process objects are intended to be supplied,
determining resource information, wherein the resource information specifies those resources which are intended to be used and/or can be used for carrying out the processes,
creating a schedule on the basis of the task information, the process information and the resource information, wherein the schedule comprises details relating to
the periods in which the processes are intended to be carried out,
the resources which are intended to be used for carrying out the processes, wherein the schedule is optimized with respect to an optimization aim,
determining at least one capacity utilization value for a resource,
comparing the at least one capacity utilization value with a reference value,
in the case of a defined deviation of the capacity utilization value from the reference value: outputting a notification regarding the deviation.

According to some embodiments, a computer-implemented method comprises:
receiving task information, wherein the task information specifies at least a plurality of process objects which are each intended to be supplied to one or more processes,
receiving or determining process information, wherein the process information specifies the processes to which the process objects are intended to be supplied,
determining resource information, wherein the resource information specifies those resources which are intended to be used and/or can be used for carrying out the processes,
creating a schedule on the basis of the task information, the process information and the resource information, wherein the schedule comprises details relating to
the periods in which the processes are intended to be carried out,
the resources which are intended to be used for carrying out the processes, wherein the schedule is optimized with respect to an optimization aim,
determining at least one capacity utilization value for a resource,
comparing the at least one capacity utilization value with a reference value,
in the case of a defined deviation of the capacity utilization value from the reference value: outputting a notification regarding the deviation.

According to some embodiments, a subject of the present disclosure is the use of the computer system according to the disclosure for identifying bottlenecks in schedules for producing and/or packaging objects, in particular medicaments, crop protection agents, pesticides and/or seeds.

The disclosure is explained in more detail below without distinguishing between the subjects of the disclosure (computer system, computer program product, method, use). Rather, the explanations below are intended to apply analogously to all subjects of the disclosure irrespective of the context (computer system, computer program product, method, use) in which they are effected.

If steps are mentioned in a sequence in the present description or in the patent claims, this does not necessarily mean that the disclosure is restricted to the sequence mentioned. Rather, according to some embodiments it is conceivable that the steps can also be carried out in a different sequence or parallel to one another, unless one step builds on another step, which makes it absolutely necessary for the building step to be subsequently carried out (which, however, becomes clear in the individual case). The sequences mentioned are therefore preferred embodiments of the disclosure.

The present disclosure is used to identify bottlenecks in schedules. A schedule is a collection of information. This information relates to process objects, processes, resources (in particular operating resources, materials and employees) and times (points in time and/or periods). It is possible to gather from a schedule which processes are intended to be carried out on which process objects using which resources at which times.

According to some embodiments, process objects are (physical) objects which are supplied to one or more processes. Examples of process objects are raw materials, intermediate products and/or products. According to some preferred embodiments, the process objects are preferably products which are intended to be produced and/or packaged. They are particularly preferably medicaments, crop protection agents, pesticides and/or seeds which are intended to be produced and/or packaged.

According to some embodiments, a process is an action or a plurality of actions which is/are carried out with or on a process object. In these embodiments, the process object can be reversibly or irreversibly changed or can remain unchanged. According to some preferred embodiments, a process is preferably one or a plurality or all of the steps for packaging an object.

A resource is generally a means to pursue a goal. According to some embodiments, the goal is to successfully carry out a process or one or more process steps. A resource can be a material or non-material item. In business management, economics and organizations, it is generally understood to mean operating resources, financial resources, soil, raw materials, energy or persons (employees) and (work) time.

Resources in the sense of the present disclosure are all means that are used to carry out a process. Usually a process cannot be carried out at all without such resources. Resources are furthermore means that are usually available only to a limited extent, which is why not all processes to be carried out can be carried out simultaneously to accomplish one existing task or a plurality of existing tasks. Process objects can be treated as resources, particularly if a process object is intended to be supplied to a plurality of processes, but the process object cannot be divided and distributed among the various processes. To put it another way, a process object is a resource in the sense of the present disclosure if its availability is limited and may have a limiting effect on accomplishing one or more tasks.

The following resources, in particular, are differentiated in the present description: employees, operating resources, materials and optionally auxiliaries.

An employee is that natural person who initiates, prepares, carries out, revises, evaluates and/or supervises a process. According to some embodiments, it is conceivable for a plurality of employees to be involved in a process.

According to some embodiments, an operating resource is a means which is used to carry out a process and in so doing is not consumed and/or irreversibly changed, with the result that it can be used again in a further process after a process has been run through. According to some preferred embodiments, the operating resource is preferably an apparatus, particularly preferably an apparatus for carrying out one or more steps during the production and/or packaging of an object.

According to some embodiments, a material is a raw material, working material, semifinished product or finished product which, as starting or basic material, is intended to be incorporated in the products of an operating plant. In contrast to the operating resources, the material here is consumed and/or irreversibly changed and cannot be used in a further process after a process has been run through. Examples of materials are all materials that are included in a packaging or constitute the packaging, including the adhesives and printing inks.

According to some embodiments, it is conceivable that auxiliaries are used to carry out a process. An auxiliary is (in addition to one or more operating resources and materials) a further means which can be used when carrying out a process. According to some preferred embodiments, an auxiliary is preferably a substance or a mixture of substances or another physical object which is not part of an intermediate or end product but is used to produce and/or process it. In these embodiments, the auxiliary is preferably consumed or irreversibly changed. Examples of auxiliaries are cleaning agents, solvents, filter materials, extraction agents, compressed air, inert gas, etchants and/or the like.

Operating resources, materials, auxiliaries and/or employees are also referred to as resources in this description.

A schedule is created on the basis of a plurality of tasks to be performed. task (referred to as demand) usually specifies one or more process objects and the process or the processes which is/are intended to be carried out. The task may also specify a time limit within which a process is intended to be carried out. The task may also specify operating resources and/or materials and/or auxiliaries with which the process is intended to be carried out. The task may also specify qualifications and/or specialist knowledge which an employee must have in order to be permitted/able to carry out the process and/or to handle the process object. In one preferred embodiment, a task specifies only process objects, processes which are intended to be carried out with the process objects and optionally time limits in which the processes are intended to be carried out.

A task may comprise a plurality of (sub)tasks, and a plurality of (sub)tasks can be combined to form an (overall) task.

The information specifying a task to be performed or a plurality of tasks to be performed is contained in task information. According to some embodiments, task information is received by the computer system. Reception is effected, for example, electronically (for example via email or the like), for example via a network to which the computer system according to the disclosure is connected. According to some embodiments, it is also conceivable that task information is transmitted together with process objects. A conceivable scenario is, for example, that process objects arrive at a site and these process objects comprise task information.

The task information contains at least information relating to the process objects which are intended to be supplied to one or more processes. In any case, the process objects can be unambiguously specified on the basis of the task information.

During the production of products, the task information specifies, for example, the raw materials and/or intermediate products from which products are produced, and optionally conditions during production.

During the packaging of objects, the task information specifies, for example, the objects that are to be packaged, and optionally the type of packaging (packaging means, labelling and the like).

If the task information does not comprise all the information required for fulfilling the task, then the missing information can be determined from one or more databases on the basis of the specified process object.

According to some embodiments, it is conceivable for the process objects each to comprise a unique identifier. A process object is uniquely identifiable on the basis of such a unique identifier. The unique identifier may be a name and/or a number and/or an alphanumeric code and/or a binary code and/or the like. The unique identifier may be fitted to the process object or to a container in which the process object is situated or to a document which has been transmitted together with the process object (for example in the form of a label or an imprint or an engraving or the like). Such a unique identifier can be captured, for example, by means of input into the computer system according to the disclosure via an input means (for example a keyboard, a touchscreen, a microphone (by voice input) or the like). According to some preferred embodiments, the unique identifier is preferably present in the form of a machine-readable code, for example an optoelectronically readable code (for example a barcode or a matrix code or the like) or in the form of an electronic store which can be read by means of radio (for example as an RFID tag) or the like and can be transmitted to the computer system according to the disclosure or to some other computer system to which the computer system according to the disclosure can be connected, for example via a network, using a suitable reader (barcode scanner, camera, RFID reader or the like). However, according to some embodiments, it is also conceivable for such a unique identifier to be transmitted to the computer system according to the disclosure independently of the process object, for example electronically (as an email or the like). Further information relating to the respective process object can be determined, for example from a database, on the basis of such a unique identifier, for example the type of process object (for example which batch is involved), properties of the process object (for example hazard warnings or other warnings for handling the process object), processes which can be and/or are intended to be carried out with the process objects, process parameters for carrying out a process with the process object and/or the like.

In a similar manner to the process objects, the resources (in particular operating resources and/or materials) can also have unique identifiers, on the basis of which they can be specified and on the basis of which further information relating to these resources can be captured from one or more databases. The statements in this description relating to the unique identifiers with respect to process objects also apply analogously to resources.

According to some embodiments, it is conceivable for the task information to also comprise process information. However, according to some embodiments it is also conceivable for process information to be determined from a database on the basis of information relating to the process object (for example on the basis of the identifier of a process object). Process information specifies the process to which a process object is intended to be supplied.

An item of process information may be the process duration, for example. According to some embodiments, it is conceivable for a plurality of periods to be defined for a process, for example a period for the total duration of the process, one or more periods in which one or more operating resources are used (and therefore cannot be used in another process), and/or one or more periods in which one or more employees are busy with the process (and therefore cannot carry out another process).

A process may comprise one or more steps. The process information may comprise details relating to the individual steps, for example which steps occur, how long they last, which operating resources and/or materials and/or auxiliaries are required for a process step and/or the like.

A further item of process information may be a sequence, for example. According to some embodiments, it is conceivable that a process can be carried out only when another process has previously been carried out. It may also be the case that a process must be immediately followed by another process in order to arrive at a desired result. The sequence specifies whether one or more predecessor processes and/or one or more subsequent processes are required for a process, and possibly the point in a process chain at which a process is intended to be carried out.

A further item of process information may comprise, for example, a statement of the operating resource or the operating resources which is/are needed to carry out the process. The process information may specify an operating resource and optionally specifications for the operating resource. According to some embodiments, it is also conceivable for specifications for an operating resource to be determined, for example, from one or more databases on the basis of a unique identifier.

A further item of process information may comprise, for example, a statement of one or more materials which are used in a process. The process information can specify the respective material and optionally an amount and/or a concentration and/or a purity and/or the like for the material.

A further item of process information may comprise, for example, a statement of one or more auxiliaries which are used in a process. The process information can specify an auxiliary and optionally an amount and/or a concentration and/or a purity and/or the like for the auxiliary.

If all information needed to specify the task(s) has been received and/or determined, the resources needed for the task(s) are determined. Resources are all means needed to perform the task(s) (in particular employees, operating resources, materials and/or auxiliaries). Information relating to the available resources is usually stored in a database or in a plurality of databases.

The information relating to the available resources (resource information) can be subdivided into employee information, operating resource information, material information and possibly auxiliary information. Further categories and subgroups of resource information are conceivable.

Employee information comprises a list of the available employees. Employee information preferably also comprises restrictions with respect to the employees, for example if an employee is not available at any time. Therefore, the employee information preferably comprises employee availabilities. Individual employee availabilities are preferably stored for each individual employee. Employee availabilities are understood as meaning periods in which the respective employee is available to carry out one or more processes. These are normally the working hours minus the break times and holiday times and other planned absences (for example business trips, treatment, training or the like). The employee availabilities are usually stored in one or more databases. If an employee is not available for a period in an unplanned manner (for example as a result of an illness), the employee availability can be accordingly changed (updated) in the database.

The employee information can also comprise employee profiles. According to some embodiments, there is preferably an individual employee profile for each individual employee. According to some embodiments, it is conceivable that defined training is required and/or a defined qualification must be present and/or specialist knowledge must be demonstrated and/or a particular physical condition must be present in order to carry out particular processes and/or to use particular operating resources and/or to handle particular types of (process) objects. The employee profile can therefore indicate, in particular, which processes can be and/or may be carried out by the employee and/or which operating resources can be and/or may be used by the employee and/or which types of (process) objects can be and/or may be handled by the employee.

The operating resource information comprises a list of the available operating resources. The operating resource information preferably comprises operating resource profiles. An operating resource profile may indicate, for example, the processes and/or types of process objects for which the respective operating resource can be and/or may be used. According to some embodiments, it is also conceivable that operating resources can be used only in defined periods, for example because they are used elsewhere in other periods and/or because they may be used only in particular periods (for example for reasons of environmental protection, emission protection, noise protection or the like) and/or regular maintenance work and/or quality tests are required. The operating resource information therefore preferably comprises operating resource availabilities which indicate when an operating resource is ready for use/available.

According to some embodiments, the material information indicates what materials are present in what amounts and possibly in what purity and/or concentration the materials are present and possibly the restrictions to which the use of a material is subject.

According to some embodiments, it is conceivable for the resource information to also comprise auxiliary information. The auxiliary information can indicate, for example, what amount and/or concentration and/or purity of an auxiliary is available, and possibly the restrictions to which the use of an auxiliary is subject.

According to some embodiments, a schedule is created. The schedule indicates a possibility for how the tasks can be performed with the available resources. In some embodiments, the schedule is the result of an optimization method. This means that, with respect to an optimization aim, that schedule which satisfies the optimization aim earliest is determined (in these embodiments it is conceivable that the global maximum or minimum is not identified during the optimization, but rather the search for the global maximum or minimum is terminated after a defined period for reasons of process efficiency and the best solution identified before the termination (local maximum or minimum) is used to create a schedule). According to some embodiments, it is also conceivable that not all tasks are taken into account in the schedule, in particular not when the schedule is created for a defined period which is insufficient to perform all tasks with the given resources. Such tasks which are not taken into account in the schedule are referred to as disregarded tasks in this description.

The schedule is preferably created by means of a linear optimization method. A mathematical method in which a target function is minimized or maximized while heeding different secondary conditions (restrictions) is referred to as linear optimization or linear programming, in which case the variables in the target function and secondary conditions occur only to the first power.

The target function indicates the criteria according to which the schedule should be optimized. The boundary conditions result, for example, as equations and/or inequalities which represent the limited availability of resources in relation to the tasks to be performed.

These embodiments provide the advantage that one of the numerous known linear optimization methods can be used for the optimization (see, for example, T. Unger, S. Dempe: Lineare Optimierung, Vieweg+Teubner, 2010, ISBN 978-3-8351-0139-5).

A mixed integer linear optimization method is particularly preferably used (see, for example, R. Mansini et al.: Linear Mixed Integer Programming for Portfolio Optimization, Springer 2015, ISBN 978-3-319-18481-4).

According to some embodiments, the number of process objects processed (supplied to a process) in a defined period is maximized using the target function. According to some embodiments, it is also conceivable for the period for performing all pending tasks to be minimized. According to some embodiments, it is also conceivable for the utilization of the operating resources to be maximized. According to some embodiments, it is also conceivable for the number of process objects to be processed in a period to be maximized. According to some embodiments, it is also conceivable for the periods in which employees are inactive to be minimized. According to some embodiments, it is also conceivable for costs for the downtimes of operating resources to be minimized. According to some embodiments, it is also conceivable for performed tasks to be associated with a value and for this value to be maximized. Further optimization aims are conceivable.

A corresponding target function is formulated (formed) on the basis of the task(s) to be performed and the associated optimization aim. Corresponding boundary conditions are formulated (formed) on the basis of the resource information.

The target function and the boundary conditions are preferably formulated in an automated manner. Corresponding programs which formulate a target function with boundary conditions on the basis of the task information and the resource information can be produced, for example, by means of Python, Matlab and/or other comparable programming languages.

According to some embodiments, the mathematical equations (inequalities) can then be supplied to a computer program for solving linear equations (inequalities) systems (for example Gurobi™ Solver (www.gurobi.com)). According to some embodiments, the solution to the equations (inequalities) system is then transformed into a schedule. Examples of the creation of schedules are found in EP3188096A1 and US20160148137.

According to some embodiments, the schedule or parts of the latter can be output on an output unit. In these embodiments, the schedule or parts of the latter can be displayed on a screen, can be output on a printer and/or can be stored in a data memory. According to some preferred embodiments, the schedule is preferably graphically represented. According to some preferred embodiments, the schedule preferably comprises different views, for example a representation which shows, for one or more employees, the times at which the employees supply which process objects to one or more processes and/or which processes are carried out by the employees and/or a representation which shows, for one or more operating resources, the periods in which they are used when performing which process. Further views are conceivable. According to some preferred embodiments, an individual employee (group) schedule is created for each individual employee or a group of employees who carries (carry) out at least one process within the scope of the created schedule and is preferably displayed only to the employee (employee group) and possibly to one or more technical supervisors and/or disciplinary supervisors of the employee (employee group). The individual employee (group) schedule indicates, for the respective employee (the respective employee group), periods and those processes which are intended to be carried out by the employee (group) in the periods. According to some preferred embodiments, the computer system according to the disclosure is preferably configured in such a manner that employees (employee groups) see only those parts of the schedule (can have an output of them) which relate to them.

In some preferred embodiments, operating resource information, employee information, auxiliary information, and/or task information is available in table form in one or more relational databases. According to some embodiments, the computer system according to the disclosure is configured to determine or parameterize the utilization function, including the boundary conditions, by means of the stored data “at the press of a button”, to solve the resulting equation/inequality system and to graphically represent the solution in the form of a schedule.

According to some embodiments, the computer system may be configured to create a schedule for a defined period, for example for one day or several days (2, 3, 4, 5 or 6 days) or a working week or one week or two weeks or three weeks or four weeks or one month or several months. According to some embodiments, it is conceivable that not all tasks to be performed can be performed in the defined period; it is therefore conceivable that, after the creation of a schedule for a defined period, tasks remain which are not taken into account in the schedule. According to some preferred embodiments, the computer system according to the disclosure is preferably configured to output such remaining tasks, for example to display them on a screen, to print them on a printer and/or to store them in a data memory.

Once a schedule has been created and the existing resources have been distributed among the processes in order to fulfil the present task(s), one or more capacity utilization values is/are determined for one resource or for a plurality of resources. The capacity utilization value for one resource indicates how much of the capacity of the resource already has procedures (processes) assigned to it within a defined period. From the capacity utilization value it is accordingly possible to determine which resources would still have capacity for further procedures and which resources are already fully utilized and therefore have no more capacity for further procedures. The capacity utilization value is preferably a degree of capacity utilization, which is the proportion constituted by the used capacity of the resource in the total available capacity within a defined period. The period may be that period for which the schedule has been created. However, it can also be a period within the period for which the schedule has been created. According to some embodiments, it is also conceivable for the period at least proportionally to comprise a plurality of periods for which the schedules have been created.

Since the capacity utilization is usually not constant over the period of time, the capacity utilization value (if appropriate the degree of capacity utilization) is usually a mean value, preferably the arithmetic mean.

The calculation of a degree of capacity utilization is explained on the basis of an example for a machine (operating resource). For this purpose, it is assumed that the machine can in principle be used permanently (24 hours a day, 365 days a year) (=available capacity). However, if the machine is used only for 2 hours per day (in a value-adding manner) in the context of a created schedule, then the used capacity (2 h/day) is less than the available capacity; the degree of capacity utilization is 2/24=1/12=0.083̅=8.3̅%. A machine is rarely usable permanently (in a value-adding manner). Therefore, retooling periods, maintenance and repair periods, rest periods and other periods in which the machine is not usable (in a value-adding manner) usually have to be subtracted in order to calculate the available (value-adding) capacity.

In some preferred embodiments, capacity utilization values are calculated for operating resources and/or groups of operating resources. A group of operating resources can be a packaging line, for example, which consists of various units (each of which by itself can be an operating resource). Capacity utilization values are preferably calculated for employees and/or employee groups as well. Capacity utilization values can be calculated for materials as well.

Preferably, there is at least one reference value for each calculated capacity utilization value. Each capacity utilization value is compared with (its) at least one reference value. In the case of a defined deviation between the respective capacity utilization value and (its) at least one reference value, a notification regarding the deviation is created and output.

The outputting is effected with the aid of an output unit. The notification can, for example, be displayed on a screen, be output on a printer and/or be stored in a data memory.

In some preferred embodiments, there is an upper threshold value as reference value for each calculated degree of capacity utilization. If the calculated degree of capacity utilization is greater than the threshold value, then this may indicate that, in the context of the existing schedule, the respective resource is utilized to such a high level that it may constitute a bottleneck for the tasks to be fulfilled. According to some embodiments, the threshold value is preferably in the range of 0.9 to 1 or 90% to 100%.

According to some embodiments, the notification regarding the deviation preferably comprises a detail regarding the respective resource for which the degree of deviation lies above the upper threshold value, and optionally a detail regarding the magnitude of the degree of deviation and/or a value that correlates with the magnitude of the degree of deviation. On the basis of the notification, a user can recognize which resources are greatly utilized. It may be the case that the respective resource already constitutes a bottleneck; there is at least the risk that the respective resource might become a bottleneck (for example if it fails unexpectedly).

In some preferred embodiments, there is a lower threshold value as reference value for each calculated degree of capacity utilization. If the calculated degree of capacity utilization is less than the threshold value, then this may indicate that the respective resource is underutilized in the context of the existing schedule. According to some preferred embodiments, the threshold value is preferably in the range of 0 to 0.5 or 0% to 50%.

According to some embodiments, the notification regarding the deviation preferably comprises a detail regarding the respective resource for which the degree of deviation lies below the lower threshold value, and optionally a detail regarding the magnitude of the degree of deviation and/or a value that correlates with the magnitude of the degree of deviation. On the basis of the notification, a user can recognize which resources are underutilized. The resource may be exchanged for a more cost-effective resource with a lower available capacity, and/or the resource may be retooled and/or qualified such that it can be used for processes for which it has not been used, in order to relieve the burden on greatly utilized resources.

In some particularly preferred embodiments, for each calculated degree of capacity utilization, the calculated degrees of capacity utilization are compared with an upper threshold value and with a lower threshold value. For all resources for which the degree of capacity utilization is either above the upper threshold value or below the lower threshold value, one or more notifications may be effected. In the notification/notifications, the respective resources may be specified; optionally, the magnitudes of the degrees of capacity utilization or values that correlate with the magnitudes of the degrees of capacity utilization may be specified.

Pairs or groups of corresponding resources are preferably produced. Corresponding resources are resources of the same type. All employees may be a resource of the same type. The employees within a group of employees may be a resource of the same type. Operating resources that perform comparable functions (printing, cutting, moving, etc.) may be resources of the same type.

By way of example, employees who are greatly utilized can be compared with those employees who are underutilized. In general, the underutilized employees will not directly be able to undertake tasks of the greatly utilized employees, since otherwise a uniform distribution of the tasks would already have been able to be attained during the creation of the schedule by way of a corresponding target function or boundary conditions. From such a comparison, however, a user can infer which of the underutilized employees may be qualified to undertake tasks of the greatly utilized employees. Corresponding qualification measures can be taken to eliminate the existing bottlenecks and to achieve a higher performance in the long term.

When comparing the degrees of capacity utilization of resources that are used within a process or a process chain, it is possible to identify those resources which are speed-determining for the respective process or the process chain (and thus constitute a bottleneck). It is then possible to take measures to fortify the speed-determining resources. This, too, results in an increase in performance in the long term.

### BRIEF DESCRIPTION OF THE DRAWINGS

The disclosure will now be described, by way of example only, with reference to the accompanying drawings, in which:

FIG. 1 shows an exemplary schematic of a computer system according to some embodiments;

FIG. 2 shows an exemplary schematic of a flowchart that describes a method that can be executed by a computer system according to some embodiments; and

FIG. 3 shows an exemplary schematic of a schedule according to some embodiments.

### DETAILED DESCRIPTION OF EXEMPLARY EMBODIMENTS

The disclosure is explained in more detail below with reference to figures, without wishing to restrict the disclosure to the features and combinations of features shown in the figures.

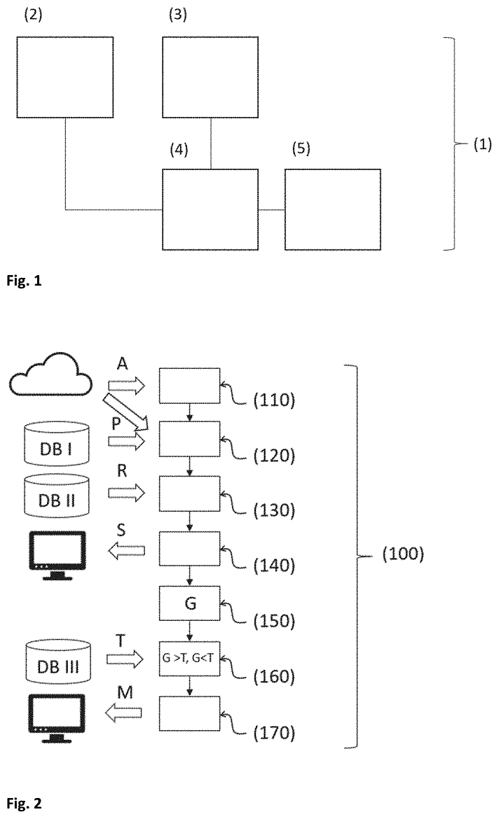

FIG. 1 shows an exemplary schematic of a computer system according to some embodiments.

The computer system (1) comprises a database (2), a receiving unit (3), a control and computing unit (4) and an output unit (5).

The database (2) stores information relating to the available resources, in particular the available employees and operating resources, preferably in table form.

Task information which provides information on process objects which are intended to be supplied to one or more processes is received via the receiving unit (3). The control and computing unit (4) serves to control the components of the computer system and to coordinate the data flows. By means of the control and computing unit (4), a schedule is created on the basis of the data stored in the database (2) and on the basis of the information received via the receiving unit (3).

The schedule or a part thereof can be output via the output unit (5). Furthermore, the control and computing unit (4) determines capacity utilization values for the resources that are employed and/or used for carrying out the processes in accordance with the calculated schedule, for a period of time. The control and computing unit (4) compares the capacity utilization values with reference values and, in the case of a defined deviation, outputs one or more notifications via the output unit (5).

FIG. 2 shows an exemplary flowchart schematic that describes a method according to some embodiments. The method (100) comprises:

At Step (110), receiving task information (A), wherein the task information (A) specifies at least a plurality of process objects which are each intended to be supplied to one or more processes;

At Step (120), receiving and/or determining process information (P), wherein the process information (P) specifies the processes to which the process objects are intended to be supplied;

At Step (130), determining resource information (R), wherein the resource information (R) specifies those resources which are intended to be used and/or can be used for carrying out the processes;

At Step (140), creating a schedule (S) on the basis of the task information (A), the process information (P) and the resource information (R), wherein the schedule (S) comprises details relating to:

the periods in which the processes are intended to be carried out; and

the resources which are intended to be used for carrying out the processes, wherein the schedule is optimized with respect to an optimization aim;

At Step (150), determining at least one capacity utilization value (G) for a resource;

At Step (160), comparing the at least one capacity utilization value (G) with a reference value (T),

At Step (170), in the case of a defined deviation of the capacity utilization value (G) from the reference value (T), outputting a notification (M) regarding the deviation.

According to some embodiments, the task information may be communicated electronically via a network to which the computer system is connected (represented by the “cloud” as the source of the task information (A)). According to some embodiments, the task information may be input by a user via an input unit of the computer system.

According to some embodiments, the process information (P) can likewise be communicated electronically via a network. According to some embodiments, it is also conceivable for process information (P) to be input by a user via an input unit of the computer system and/or to be read from a database (DB I).

The resource information (R) may be determined on the basis of the task information (A) and the process information (P) from a database (DB II).

According to some embodiments, the schedule (S) can be output to a user via an output unit of the computer system (e.g., the schedule can be displayed on a monitor).

The at least one capacity utilization value G may be determined on the basis of the schedule for a defined period. A capacity utilization value G may be preferably determined for each of the resources used in the schedule.

Preferably, for each capacity utilization value determined, at least one reference value T, preferably two reference values T (e.g. an upper threshold value and a lower threshold value), is/are determined (e.g., from a database (DB III)) and compared with the capacity utilization value.

According to some embodiments, in the case of a defined deviation, at least one notification is output to a user via an output unit of the computer system. According to some preferred embodiments, the at least one notification preferably comprises a detail regarding those resources for which the capacity utilization value deviates in a defined manner from at least one reference value, and optionally a detail regarding the magnitude of the deviation and/or the magnitude of the degree of capacity utilization.

The databases DB I, DB II and DB III may be a single database or an arbitrary number of a plurality of databases. In this regard, a total of one, two, three, four or generally N databases may be present, where N is an integer greater than or equal to 1. That is to say that each of the databases DB I, DB II and DB III may also be part of another database or a plurality of databases.

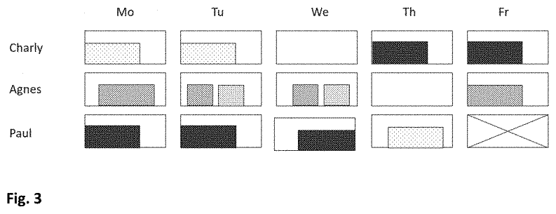

FIG. 3 shows an exemplary schedule according to some embodiments. A schedule for a working week having the working days of Monday to Friday (Mo, Tu, We, Th, Fr) is illustrated. For the individual employees (Charly, Agnes, Paul), the days on which the employees have to perform which task are illustrated. The respective task is indicated as hatching. The hatching may have different meanings; for example, hatching may indicate a process which is intended to be carried out by the respective employee. Furthermore, hatching may indicate a process object or a set of process objects which are intended to be looked after by the respective employee (by supplying them to one or more processes). Furthermore, hatching may indicate an operating resource which is intended to be operated by the respective employee (wherein the respective employee carries out one or more processes on one or more process objects using the operating resource). However, the hatching may also indicate a combination of a plurality of items (process, process object, operating resource). The size of the hatched area may indicate the period in which the respective employee is occupied with the respective task. The beginning and the end of the hatched area within the rectangle for the respective day and employee can indicate, for example, the start and end of the activities of the respective employee. The rectangle for the employee Paul on Friday is provided with a cross, which is intended to indicate that he is not available on Friday.

Further schedules and illustrations are conceivable. According to some embodiments, the computer system according to the disclosure and the computer program according to the disclosure are preferably configured in such a manner that schedules can be generated and output not only for employees, but also for process objects and/or operating resources. In these embodiments, a schedule for process objects may indicate which processes are intended to be carried out on the process objects in which periods, which operating resources are intended to be used for processing the process objects in which periods, and/or which employees are intended to manage the process objects in which periods. A schedule for operating resources may indicate which operating resources are intended to be used in which periods (for example by which employees, with which process objects and/or which processes are intended to be carried out).

1. A computer system comprising:
a database or a plurality of databases in which resource information about resources is stored;
a receiving unit;
a control and computing unit; and
an output unit;
wherein the control and computing unit is configured to:
cause the receiving unit to receive task information, wherein the task information specifies at least a plurality of process objects which are each supplied to one or more processes;
specify, based on the task information, processes to which the process objects are supplied;
specify, based on the specified processes, resources that are used for carrying out the processes;
create a schedule, wherein the schedule comprises details relating to:
periods in which the processes are carried out; and
the resources for carrying out the processes,
wherein the schedule is optimized with respect to an optimization aim;
determine a capacity utilization value for at least one resource;
compare the capacity utilization value with a reference value; and
in accordance with a defined deviation of the capacity utilization value, cause the output unit to output a notification regarding the deviation.

2. The system of claim 1, wherein the control and computing unit is configured to:
create a system of equations and/or inequalities based on the resource information and the task information;
solve the system of equations and/or inequalities via an optimization method; and
transform the solution into the schedule.

3. The system of claim 1, wherein the control and computing unit is configured to determine, for each resource used according to the schedule, a capacity utilization value for a defined period, wherein the defined period at least proportionally comprises periods for which the schedule has been created.

4. The system of claim 1, wherein the control and computing unit is configured to:
determine, for each resource used according to the schedule, a capacity utilization value; and
compare the capacity utilization value with at least one reference value.

5. The system of claim 1, wherein the control and computing unit is configured to:
determine a degree of capacity utilization for each resource used according to the schedule;
compare the degree of capacity utilization with an upper threshold value and/or with a lower threshold value; and
list in one notification or in a plurality of notifications those resources for which the degree of capacity utilization is greater than the upper threshold value or less than the lower threshold value.

6. The system of claim 5, wherein the control and computing unit is configured to contrast, in the at least one notification, resources for which the degree of capacity utilization is greater than the upper threshold value with resources of a same type for which the degree of capacity utilization is less than the lower threshold value.

7. The system of claim 1, wherein the control and computing unit is configured to define resources which have the highest degree of capacity utilization within a process or a process chain.

8. A method comprising:
receiving task information, wherein the task information specifies at least a plurality of process objects which are each supplied to one or more processes;
receiving or determining process information, wherein the process information specifies the processes to which the process objects are supplied;
determining resource information, wherein the resource information specifies resources that are used and/or can be used for carrying out the processes;
creating a schedule based on the task information, the process information and the resource information, wherein the schedule comprises details relating to:
periods in which the processes are carried out; and
the resources that are used for carrying out the processes, wherein the schedule is optimized with respect to an optimization aim;
determining at least one capacity utilization value for a resource;
comparing the at least one capacity utilization value with a reference value; and
in accordance with a defined deviation of the capacity utilization value from the reference value, outputting a notification regarding the deviation.

9. A non-transitory computer readable medium storing one or more programs, the one or more programs comprising instructions that, when executed by a processor, cause the processor to:
receive task information, wherein the task information specifies at least a plurality of process objects which are each supplied to one or more processes;
receive or determine process information, wherein the process information specifies the processes to which the process objects are supplied;
determine resource information, wherein the resource information specifies resources that are used and/or can be used for carrying out the processes;
create a schedule based on the task information, the process information and the resource information, wherein the schedule comprises details relating to:
periods in which the processes are carried out; and
the resources that are used for carrying out the processes, wherein the schedule is optimized with respect to an optimization aim;
determine at least one capacity utilization value for a resource;
compare the at least one capacity utilization value with a reference value; and
in accordance with a defined deviation of the capacity utilization value from the reference value, output a notification regarding the deviation.

10. (canceled)

11. The system of claim 1, wherein the system is configured to identify bottlenecks in the schedule.

12. The system of claim 11, wherein the schedule is configured for producing and/or packaging objects of medicaments, crop protection agents, pesticides, and/or seeds.

13. The system of claim 2, wherein the system of equations and/or inequalities is solved via a mixed integer linear optimization method.
